(19) United States
(12) Patent Application Publication
(10) Pub. No.: US 2012/0288312 A1
(43) Pub. Date: Nov. 15, 2012

(54) LABEL PRODUCTION SYSTEM AND LABEL PRODUCTION METHOD

(75) Inventor: Yuko SEKI, Hamamatsu-shi (JP)

(73) Assignee: Roland DG Corporation

(21) Appl. No.: 13/105,655

(22) Filed: May 11, 2011

(51) Int. Cl. B41J 11/44

(52) U.S. Cl. 400/76

(57) ABSTRACT

A label production system producing labels for affixation to one or more types of products successively produced in an industrial production line. The label production system includes a printer for printing on and cutting a medium, wherein the medium includes a first sheet and a second sheet laminated onto the first sheet, and wherein the printer includes an ink head for printing on the second sheet of the medium and a cutter for cutting at least the second sheet of the medium. A computer controls the printer to produce at least one label for each of one or more products produced in the production line by controlling the printer to print on and cut a contour on the second sheet of the medium.

### BACKGROUND OF THE INVENTION

1. Field of the Invention

Embodiments of the present invention relate to label production systems and label production methods.

2. Description of the Related Art

Generally, label production systems may be implemented with industrial production lines which manufacture products successively. Specifically, the label production systems produce labels to be affixed to the manufactured products.

For example, Japanese Patent Application Publication No. 10-119944 discloses a system for producing information labels to be affixed to a vehicle body placed in an assembly line. In this system, information related to the vehicle body finished with a painting process, such as model and specifications, is transmitted to a host computer from a paint line information-inputting means installed at a paint line located before the assembly line. The host computer stores the vehicle body information. A personal computer installed at the assembly line reads the vehicle body information stored in the host computer, and transmits the vehicle body information to a printer. The printer then prints information labels in the order of vehicle bodies that are placed in the assembly line. Accordingly, an assembly line worker can verify the vehicle bodies placed in the assembly line with the vehicle information printed on the information labels, and affix a corresponding information label to each vehicle body.

The information labels produced with the above system are used for clarifying interior and exterior specifications of each vehicle body in order for assembly line workers, after label affixation, to perform parts assembly without fail. Each information label is formed in the shape of a rectangle on which interior specifications, exterior specifications, and model information are printed in correspondence with each vehicle body. A plurality of information labels are arranged on a tape-shaped board, with a certain spacing between each information label. One sheet of information labels is prepared for each vehicle body, and the one sheet of information labels is affixed to the corresponding vehicle body. The above cited publication discloses that the above system removes the necessity for printing and storing a number of information labels in advance, thus facilitating efficient storage and management of information labels.

Notably, the above-mentioned information labels only notify assembly line workers of the interior and exterior specifications of each vehicle body. Also, the above-mentioned information labels have an undifferentiated form, on which only necessary information for assembly is printed. However, other types of labels exist which may be used in a production line. These other types of labels may be affixed to a product in plural numbers, each having a different form. However, these other types of labels cannot be produced with the above-mentioned label production system.

### SUMMARY OF THE INVENTION

The present invention is directed to a label production system and method.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a label production system producing labels for affixation to one or more types of products successively produced in an industrial production line, the label production system comprising a printer for printing on and cutting a medium, wherein the medium comprises a first sheet and a second sheet laminated onto the first sheet, and wherein the printer comprises an ink head for printing on the second sheet of the medium and a cutter for cutting at least the second sheet of the medium; and a computer for controlling the printer to produce at least one label for each of one or more products produced in the production line by controlling the printer to print on and cut a contour on the second sheet of the medium.

The computer comprises an input unit for receiving information for each product produced in the production line, the information related to at least a type of each product produced and an order of production, a storage unit having stored data for producing labels corresponding to each type of product produced in the production line, a reading unit for receiving the information received by the input unit and reading data from the storage unit for each product produced in the production line according to the type of each product and the order of production, a first control unit for transmitting the data read by the reading unit to the printer and controlling the printer to print on and cut a contour on the second sheet of the medium to generate the at least one label for a specific product produced in the production line according to the data read by the reading unit, and a second control unit for receiving the information received by the input unit and controlling the printer to print on the second sheet of the medium identification information for identifying a type of the specific product according to the information received by the input unit.

In an embodiment, the first control unit controls the printer to generate a plurality of labels on the second sheet of the medium to form a label sheet corresponding to the specific product according to the data read by the reading unit.

In another embodiment, the first control unit controls the printer to generate a plurality of label sheets on the second sheet of the medium according to the data read by the reading unit, wherein each of the plurality of label sheets are separated from each other on the second sheet of the medium and respectively correspond to each product produced in the production line.

In another embodiment, the input unit further receives information for identifying the specific product produced in the production line, and the identification information printed on the second sheet of the medium includes information for identifying the specific product.

In another embodiment, the at least one label comprises at least one printed character printed in a language according to a destination of the specific product produced in the production line.

In another embodiment, a shape of the at least one label is cut according to the type of the specific product produced in the production line.

In another embodiment, a number of labels in the label sheet is dependent on the type of the specific product produced in the production line.

In another embodiment, a character printed on the at least one label is dependent on the type of the specific product produced in the production line.

In another embodiment, the computer further comprises a second storage unit having stored information related to cautionary measures for the one or more products produced in the production line; and a third control unit for receiving the stored information related to the cautionary measures from the second storage unit, wherein the third control unit controls the printer to print on the second sheet of the medium a respective cautionary measure for each product produced in the production line.

In another embodiment, the input unit receives the information related to at least a type of each product produced and an order of production from a computer controlling the production line, wherein the input unit further receives from the computer controlling the production line, information related to a production status of each product produced in the production line, and wherein, for each product, a timing of the first control unit generating the at least one label and the second control unit printing the identification information is controlled according to the production status of each product.

In another embodiment, a method for producing labels for affixation to one or more types of products successively produced in an industrial production line comprises printing on and cutting a medium set into a printer, wherein the medium comprises a first sheet and a second sheet laminated onto the first sheet, and wherein the printer comprises an ink head for printing on the second sheet of the medium and a cutter for cutting at least the second sheet of the medium; controlling, via a computer, the printer to produce at least one label for each of one or more products produced in the production line by controlling the printer to print on and cut a contour on the second sheet of the medium; receiving, via an input unit of the computer, information for each product produced in the production line, the information related to at least a type of each product produced and an order of production; storing, in a storage unit of the computer, data for producing labels corresponding to each type of product produced in the production line; receiving, via a reading unit of the computer, the information received by the input unit and reading, via the reading unit, data from the storage unit for each product produced in the production line according to the type of each product and the order of production; transmitting, via a first control unit of the computer, the data read by the reading unit to the printer and controlling, via the first control unit, the printer to print on and cut a contour on the second sheet of the medium to generate the at least one label for a specific product produced in the production line according to the data read by the reading unit; and receiving, via a second control unit of the computer, the information received by the input unit and controlling, via the second control unit, the printer to print on the second sheet of the medium identification information for identifying a type of the specific product according to the information received by the input unit.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. Features, elements, and aspects of the invention that are referenced by the same numerals in different figures represent the same, equivalent, or similar features, elements, or aspects in accordance with one or more embodiments.

FIG. 1 is a configuration diagram of a production line and a label production system in accordance with an embodiment of the present invention.

FIG. 2 is a perspective view of a printer in accordance with an embodiment of the present invention.

FIG. 3A and FIG. 3B are elevational views of an ink head and a cutting head in accordance with an embodiment of the present invention.

FIG. 4 is a block diagram of a control system for a printer in accordance with an embodiment of the present invention.

FIG. 5 is a cross sectional view of a medium in accordance with an embodiment of the present invention.

FIG. 6 illustrates a label sheet in accordance with an embodiment of the present invention.

FIG. 7 illustrates another label sheet in accordance with an embodiment of the present invention.

FIG. 8 illustrates still another label sheet in accordance with an embodiment of the present invention.

FIG. 9 is a functional block diagram of a computer in accordance with an embodiment of the present invention.

FIG. 10 is a flow chart of a label production method in accordance with an embodiment of the present invention.

### DETAILED DESCRIPTION OF THE PREFERRED EMBODIMENTS

Embodiments of the present invention relate to a label production system. The label production system in accordance with an embodiment of the present invention described below is a system for implementing with an industrial production line manufacturing one or more types of products successively. The label production system produces a plurality of labels to be affixed to the manufactured products. The types of products to which the labels are affixed are not limited. For example, the manufactured products may include automobile bodies or parts, seats for vehicles or airplanes, electronic products, communication devices, and other types of machines or apparatuses.

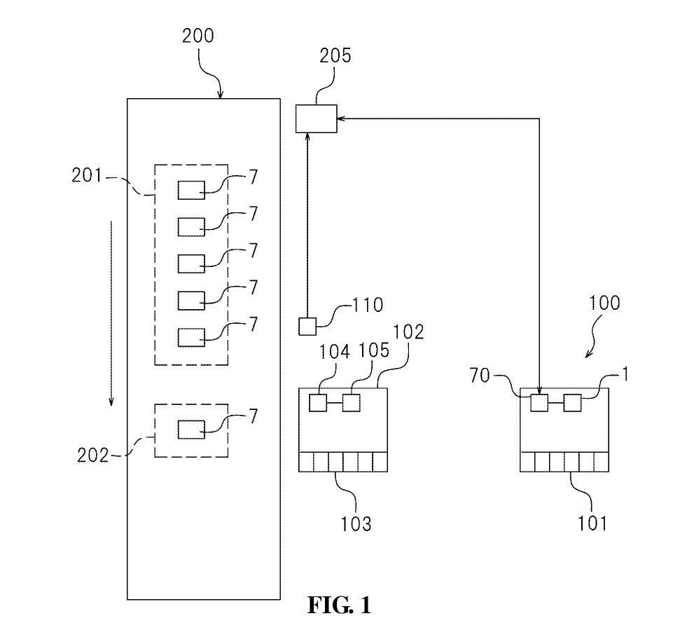

FIG. 1 illustrates a configuration example of a production line 200 and a label production system 100 in accordance with an embodiment of the present invention. The label production system 100 includes a printer 1 and a computer 70 that controls the printer 1. It is noted that FIG. 1 only illustrates one printer 1 and one computer 70; however, embodiments of the present invention may utilize a plurality of printers and computers. Moreover, the total number of printers utilized may be the same, or different, from the total number of computers utilized. For example, a plurality of printers 1 may be controlled by one computer 70. Also, the computer 70 may be any computer type, such as a desktop computer, a laptop computer, a large computer (i.e., server), and the like. The computer 70 may be structurally separate from the printer 1, or integrated with the printer 1.

The label production system 100 may be disposed in the vicinity of the production line 200, or may be disposed away from the production line 200, as shown in FIG. 1. Furthermore, the label production system 100 may be disposed in the same building with the production line 200, or may be disposed in a different building. The computer 70 of the label production system 100 may be connected with a production line computer 205 that controls the production line 200 in a wired or wireless manner, such that communication therebetween is facilitated. The computer 70 may be connected with the production line computer 205 either directly or via a network.

The production line 200 includes an assembly line 201 for assembling a product 7. An affixation line 202 for affixing a label to the assembled product 7 is disposed at a downstream side of the assembly line 201. A workspace 102 for an assembly line worker to perform a label-affixing operation is provided before the affixation line 202. A shelf 103 for storing label sheets is disposed in the workspace 102.

In the production line 200, different types of products 7 may be produced successively. The types of products may differ, for example, because of at least one of a shape, dimension, pattern, color, material, etc. of the products. The printer 1 produces a label sheet that includes a set of labels suitable for each product 7 according to a type of the product 7 produced in the production line 200 and the order of production. A shelf 101 that stores produced label sheets is disposed in the vicinity of the printer 1.

The label sheet produced with the printer 1 is stored in the shelf 101 by a worker. The label sheet may then be moved from the shelf 101 to the shelf 103 in an appropriate manner. In the workspace 102, a worker takes a label sheet from the shelf 103 and affixes a set of labels on the label sheet to the product 7 located on the affixation line 202.

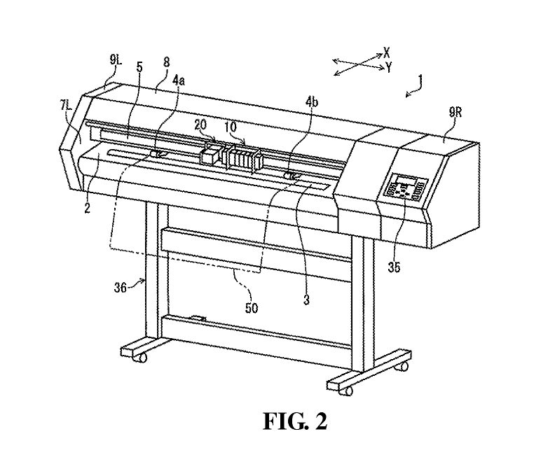

The following is a description of the printer 1. FIG. 2 is a perspective view of the printer 1 in accordance with an embodiment of the present invention. The printer 1 is provided with a cutting head to allow printing on and cutting of a medium 50. The printer 1 includes an ink head 10 and a cutting head 20. The ink head 10 and the cutting head 20 are movable in a Y direction, as shown in FIG. 2, the details of which will be described below. Hereinafter, the Y direction may be referred to as a main scanning direction, while an X direction, as shown in FIG. 2, may be referred to as a sub-scanning direction.

In the present embodiment, the print head that performs printing is the ink head 10 discharging ink. However, the print head of the printer 1 is not limited to the ink head 10. The print head may be a print head of another type such as a dot impact type print head, for example.

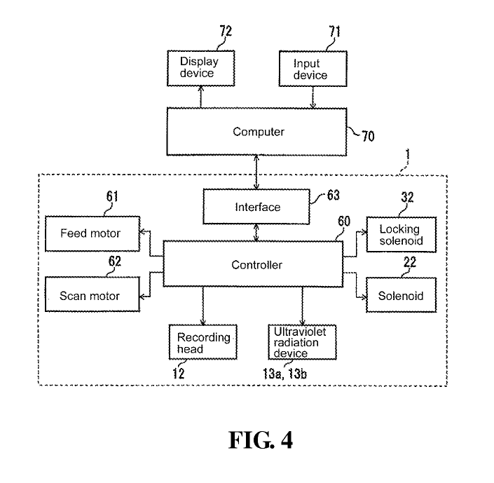

The printer 1 includes a platen 2 that supports a medium 50 at the time of printing and cutting. The platen 2 is provided with a grid roller 3. The grid roller 3 is driven by a feed motor 61 (see FIG. 4). A guide rail 5 that extends in the Y direction is disposed above the platen 2. Pinch rollers 4a and 4b are disposed below the guide rail 5. The pinch rollers 4a and 4b are attached to the guide rail 5 such that they may vertically swing with respect to the guide rail 5. The pinch rollers 4a and 4b oppose the grid roller 3. When the grid roller 3 rotates in a state where the medium 50 is inserted between the pinch rollers 4a, 4b and the grid roller 3, the medium 50 is moved either forward or rearward.

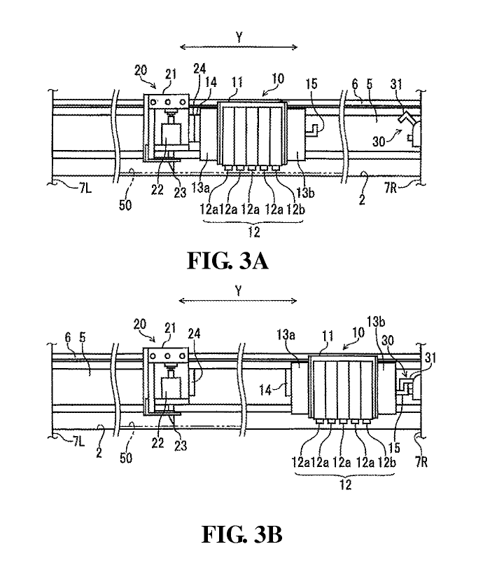

As shown in FIG. 3A, the ink head 10 is supported by the guide rail 5 via a carriage 11. The cutting head 20 is supported by the guide rail 5 via a carriage 21. The carriage 11 and the carriage 21 are engaged with the guide rail 5 such that they may horizontally slide along the guide rail 5.

As shown in FIG. 3A, a cutter 23 is disposed in the carriage 21 via a solenoid 22. The solenoid 22 is controlled by a controller 60 (see FIG. 4). According to an ON/OFF operation of the solenoid 22, the cutter 23 is moved down into contact with the medium 50, or moved up to separate from the medium 50. A coupling member 24, formed of a magnetic material, is fixed to a right side of the carriage 21.

A wire 6 that extends in the Y direction is partially fixed to an upper portion of a back surface of the carriage 21. The wire 6 is connected to a scan motor 62 (see FIG. 4). When the scan motor 62 rotates, the wire 6 is displaced either to the left or right. Accordingly, the carriage 21 moves either to the left or right. The scan motor 62 is controlled by the controller 60.

An ink jet type recording head 12 is supported by the carriage 11 of the ink head 10. Here, four recording heads 12a and one recording head 12b are supported by the carriage 11. The four recording heads 12a each discharge a different color of ink, specifically, yellow, magenta, cyan and black. The ink discharged by the four recording heads 12a may be referred to as a process color ink. The one recording head 12b discharges a white or clear ink, which may be referred to as a special color ink. In accordance with embodiments of the present invention, the number of recording heads 12a is not limited to four, and the number of recording heads 12b is not limited to one. Moreover, the recording head 12b for discharging the special color ink may be removed from the ink head 10. Also, the recording head 12a may be a recording head that forms monochromatic images.

In the present embodiment, the ink discharged from the recording heads 12a and 12b may be an ultraviolet curable ink, which is cured when irradiated with ultraviolet light. Notably, the ink used in accordance embodiments of the invention is not limited to the ultraviolet curable ink. Various types of conventional printer ink may suitably be used. If the ultraviolet curable ink is not used, then ultraviolet radiation devices 13a and 13b described below are not necessary and may be removed.

As shown in FIG. 3A, the ultraviolet radiation devices 13a and 13b are respectively disposed on left and right sides of the carriage 11. In accordance with embodiments of the present invention, the ultraviolet radiation devices 13a and 13b are not limited to a particular type. However, by way of example, the ultraviolet radiation devices 13a and 13b of the present embodiment is provided with a light emitting diode (LED) (not shown) that radiates ultraviolet light. The ultraviolet radiation devices 13a and 13b may also be provided with another type of radiation device such as a halogen lamp. The ultraviolet radiation devices 13a and 13b radiate the ultraviolet light downwards. Accordingly, the medium 50 on the platen 2 is exposed to the ultraviolet light, and the ultraviolet curable ink on the medium 50 is cured.

A coupling member 14 formed of a magnetic material is disposed on the left side of the left ultraviolet radiation device 13a. The coupling member 14 is removably coupled to a coupling member 24 of the cutting head 20. The coupling member 14 and the coupling member 24 may utilize a magnetic force to adhere to one another. However, means for coupling the coupling member 14 and the coupling member 24 are not limited to a magnetic force. Other means may be used, such as an engaging member. An L-shaped receiving member 15 is disposed on the right side of the right ultraviolet radiation device 13b.

Side frames 7L and 7R are respectively arranged on left end and right end portions of the platen 2. The guide rail 5 is supported by both side frames 7L and 7R. The side frame 7R on the right side is provided with a lock device 30 that locks the ink head 10 in a standby position. The lock device 30 includes a receiving member 31 that may be hooked onto the L-shaped receiving member 15 of the ultraviolet radiation device 13b. The lock device 30 also includes a solenoid 32 (see FIG. 4) that moves the receiving member 31 between a locked position (see FIG. 3B) and an unlocked position (see FIG. 3A). The solenoid 32 is controlled by the controller 60.

As shown in FIG. 3A, when printing is performed by the ink head 10, the receiving member 31 is set to the unlocked position. When the carriage 21 of the cutting head 20 moves to the right to bring the coupling member 24 and the coupling member 14 into contact with each other, the carriage 21 and the carriage 11 are coupled. As a result, the ink head 10 can be moved to the right or left together with the cutting head 20. When cutting is performed by the cutting head 20, as shown in FIG. 3B, the ink head 10 is placed in the standby position and the receiving member 31 of the lock device 30 is set to the locked position. Accordingly, motion of the ink head 10 is prevented. When the carriage 21 moves to the left, the coupling member 24 separates from the coupling member 14 to release the coupling between the carriage 21 and the carriage 11. As a result, the cutting head 20 can be moved right and left while the ink head 10 is kept in the standby position.

As shown in FIG. 2, the printer 1 includes an upper cover 8 that forms an upper case. Side covers 9L and 9R are respectively disposed on the left side of the side frame 7L and the right side of the side frame 7R (see FIG. 3A). An operation panel 35 is arranged on the front face of the side cover 9R on the right side of the printer 1. A stand 36 with casters is provided under the platen 2.

As shown in FIG. 4, a controller 60 is communicatively connected via an interface 63 to the computer 70. The controller 60 may comprise electrical components, such as a CPU, ROM, RAM and the like (not shown). Supplied software for the printer 1 is installed in the computer 70. The controller 60 receives data from the computer 70 and controls a feed motor 61, a scan motor 62, the solenoid 32 of the lock device 30, the solenoid 22 of the cutting head 20, the recording head 12 of the ink head 10, and the ultraviolet radiation devices 13a and 13b. The computer 70 is connected to an input device 71 which may be a keyboard, mouse or other input means, and to a display device 72 which may be a liquid crystal display or other display means.

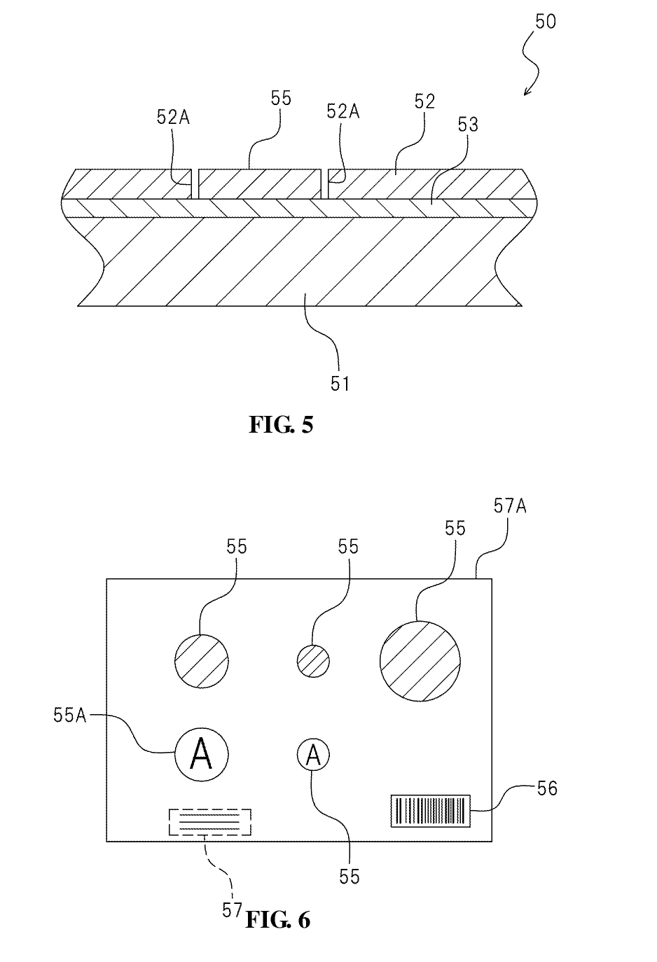

FIG. 5 is a cross-sectional view of the medium 50. The medium 50 includes a first sheet 51, and a second sheet 52 that is laminated onto the first sheet 51 via an adhesive 53. The first sheet 51 and the second sheet 52 may be made of any type of material. Exemplary materials include resin, paper, etc. The ink head 10 performs printing on the surface of the second sheet 52. The cutter 23 of the cutting head 20 is capable of cutting through the entire thickness of the medium 50. In other words, the cutter 23 can cut through the second sheet 52, the adhesive 53, and the first sheet 51. Moreover, the cutter 23 is capable of cutting through the second sheet 52 only. A label 55 is formed by cutting a contour 52A out of the second sheet 52. In accordance with the embodiment of the invention, a label sheet comprising a plurality of labels 55 may be produced on the medium 50, and the entire thickness of the medium 50 may be cut. As a result, a plurality of label sheets, separated from one another, can be produced from one sheet of the medium 50.

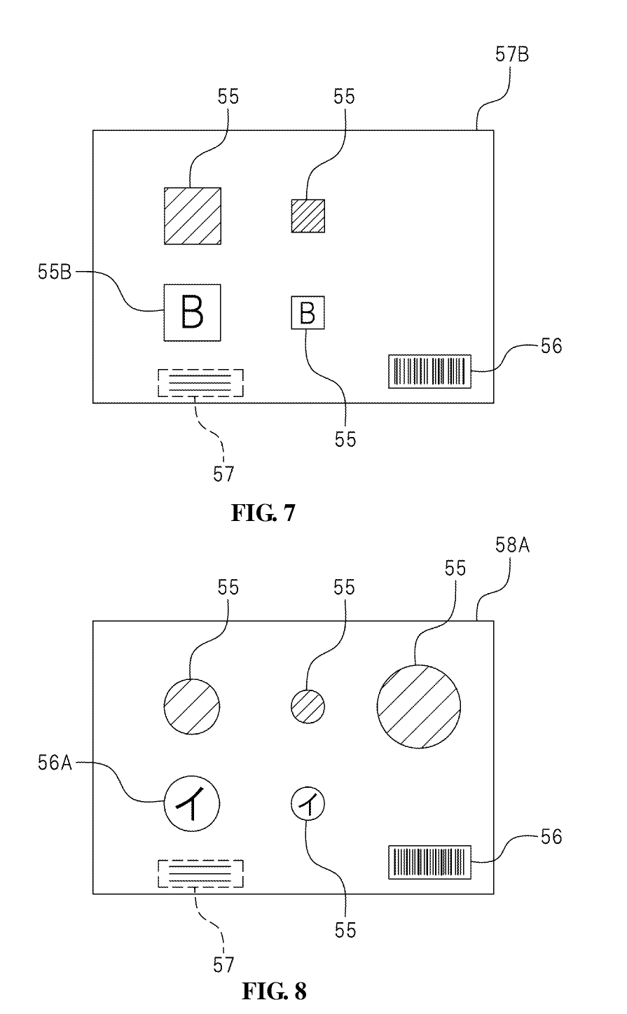

FIGS. 6 to 8 illustrate exemplary label sheets in accordance with embodiments of the present invention. FIG. 6 illustrates a label sheet 57A for a U.S. product model A. FIG. 7 illustrates a label sheet 57B for a U.S. product model B. FIG. 8 illustrates a label sheet 58A for a Japanese product model A.

Referring to FIGS. 6 and 7, the label sheet 57A and the label sheet 57B are destined for the same country (U.S.). Thus, both label sheets may be printed in the same language. However, because the product for the label sheet 57A (product model A) is different from the product for the label sheet 57B (product model B), a number and/or shape of labels 55 on the label sheet 57A may differ from the number and/or shape of the labels 55 on the label sheet 57B. For example, the label sheet 57A comprises five circle-shaped labels 55 while the label sheet 57B comprises four square-shaped labels 55. Moreover, the actual letters, characters or words printed on the labels 55 may differ for each of the label sheets 57A and 57B. For example, although the label 55A of the label sheet 57A is printed in the same language as the label 55B of the label sheet 57B, the letter printed on the label 55A (“A”) is different from the letter printed on the label 55B (“B”).

Referring to FIGS. 6 and 8, the label sheet 57A and the label sheet 58A are for the same product model (product model A), but are destined for different countries (U.S. and Japan). Therefore, a number and shape of the labels 55 on the label sheet 57A are the same as the number and shape of the labels 55 on the label sheet 58A. However, the labels 55 on the label sheet 57A are printed in a different language from the labels 55 on the label sheet 58A. For example, the character printed on the label 55A of the label sheet 57A is of a different language from the character printed on the label 56A of the label sheet 58A. Accordingly, the label sheets 57A, 57B, and 58A may each be produced specifically for a destination and model of a product 7.

The printer 1 is capable of printing various types of information. That is, the printer 1 can print other types of information in addition to the information printed on a set of labels 55 required by the product 7. Areas outside of the labels 55 on the label sheets 57A, 57B, and 58A may be printed on or cut. For example, the label sheets 57A, 57B, and 58A may each be printed with a serial number of the product 7 to which a label 55 of the label sheets 57A, 57B, and 58A is affixed. As shown in FIGS. 6 to 8, the label sheets 57A, 57B, and 58A may each be printed with a barcode 56 that may include information regarding the serial number of the product 7.

In accordance with embodiments of the present invention, when an assembly line worker manipulates any of the label sheets 57A, 57B, and 58A with respect to the product 7, the worker may have to be mindful of any cautionary measures needed when affixing a label 55 to the product 7, or when handling the product 7 itself. Accordingly, such cautionary measures 57 may be printed on the label sheets 57A, 57B, and 58A.

Additionally, the computer 70 can receive information regarding a production status of the production line 200 from the computer 205. The computer 70 can also print the production status information on the label sheets 57A, 57B, and 58A by using the printer 1.

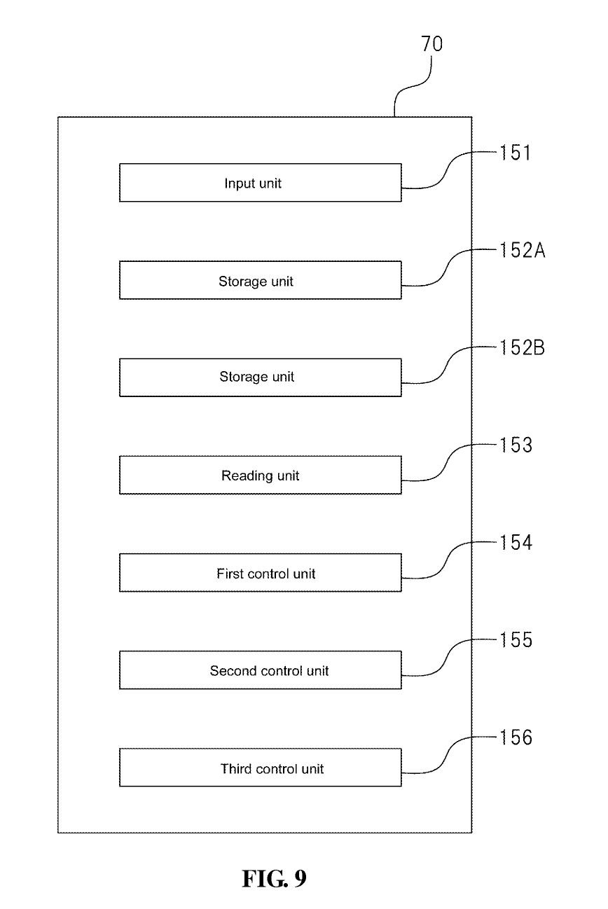

FIG. 9 is a functional block diagram of the computer 70 in accordance with an embodiment of the present invention. The computer 70 performs functions based on a computer program stored in a built-in memory or based on a computer program read from a computer readable storage medium. The computer readable storage medium may include, for example, USB memories, hard disc drives, CD-Rs, and DVDs.

As shown in FIG. 9, the computer 70 includes an input unit 151, a storage unit 152A, a storage unit 152B, a reading unit 153, a first control unit 154, a second control unit 155, and a third control unit 156. The input unit 151 receives, at least, information regarding a type and production order of the product 7 produced in the production line 200. The storage unit 152A stores data for producing a set of labels suited for various types of the product 7. The storage unit 152B stores data regarding cautionary measures related to the product 7. The reading unit 153 receives the information from the input unit 151, and reads the data for the product 7 from the storage unit 152A according to the type and production order of the product 7 produced in the production line 200. The first control unit 154 transmits the data read by the reading unit 153 to the printer 1, and controls the printer 1 to perform printing and cutting according to each product 7. The first control unit 154 produces a label sheet, using the printer 1, from the medium 50 according to each product 7. The second control unit 155 receives the information from the input unit 151, and controls the printer 1 to print on the label sheet at least identification information for identifying a type of each product 7. The third control unit 156 receives information regarding cautionary measures from the storage unit 1526, and controls the printer 1 to print the cautionary measures on each label sheet in accordance with each product 7.

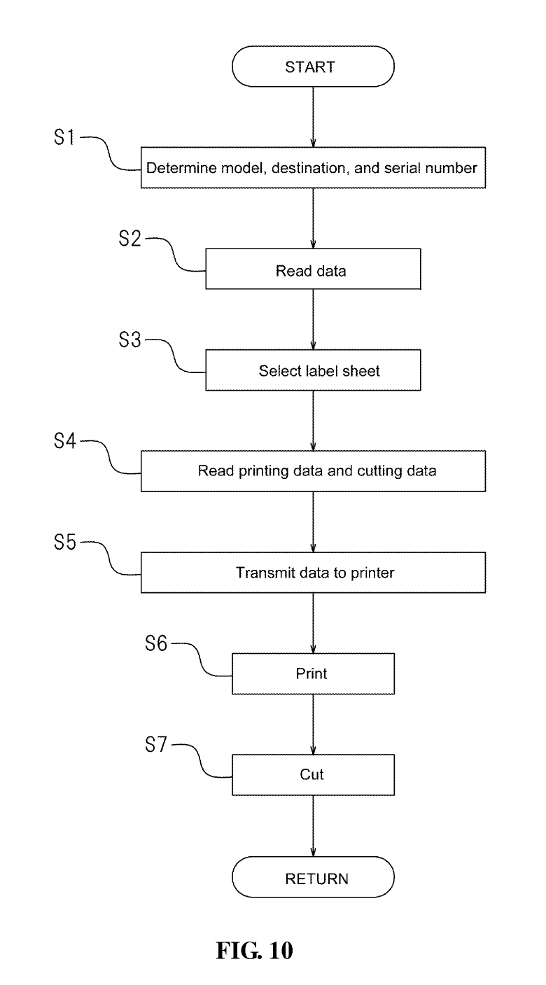

FIG. 10 describes a label production method for the label production system 100 in accordance with an embodiment of the present invention. As shown in FIG. 10, the computer 205 determines a model, a destination, and a serial number of the product 7 and transmits the data to the computer 70 (S1). The input unit 151 of the computer 70 reads the data from the computer 205 (S2). Meanwhile, at the production line 200, the product 7 is produced. Accordingly, the reading unit 153 of the computer 70 selects a label sheet suitable for the product 7 by referring to the data stored in the storage unit 152A (S3). The reading unit 153 then reads printing data and cutting data for producing the label sheet from the data stored in the storage unit 152A (S4). The first control unit 154 of the computer 70 transmits the printing data or the cutting data to the printer 1 (S5). Moreover, the second control unit 155 of the computer 70 transmits identification information data of the product 7 to the printer 1 (S5). Also, the third control unit 156 of the computer 70 transmits to the printer 1 data regarding cautionary measures related to the product 7. Upon receiving this data, the printer 1 performs printing and cutting of the medium 50 (S6, S7), thus producing a label sheet in which a set of labels 55 suitable for the product 7, identification information such as the barcode 56 and cautionary measures 57 related to the product 7, are printed.

In an embodiment of the label production system 100, independent label sheets having a set of labels suitable for each product 7 can be produced. According to the embodiment, the set of labels needed for each product 7 does not have to be produced and stored individually. Therefore, label production is more efficient and label production management is less burdensome. Moreover, according to the embodiment, multiple labels for one product 7 are better organized, thus preventing the affixation of an incorrect label on the product. Hence, affixation of labels is performed more accurately and easily.

In an embodiment of the label production system 100, label sheets can be produced in accordance with a production status of the production line 200. For example, label sheets may be produced in accordance with a production timing of the product 7. The timing of label sheet production may be adjusted so that the label sheets are delivered to the workspace 102 when the product 7 is carried to the affixation line 202 or immediately before the label 55 is affixed to the product 7. Accordingly, the necessity for storing a large number of label sheets in the shelf 101 or the shelf 103 is eliminated, thus reducing storage space for the label sheets.

In an embodiment, the label sheets are printed with unique identification information related to each product 7. Thus, when a label sheet is affixed, the label sheet can easily be checked whether it is suitable for the target product 7. For example, if the products 7 are each stamped with a unique serial number and the label sheets are respectively printed with a serial number for each respective product 7, the serial numbers can be visually verified by an assembly line worker to determine whether the label sheet corresponds to the particular product.

Alternatively, instead of a visual check conducted by the worker, a machine may be used. For example, a barcode 56 (see FIGS. 6 to 8) including identification information (e.g., serial number) related to the product 7 may be printed on the label sheet. Moreover, a barcode reader 104 and a computer 105 for processing information read by the barcode reader 104, as shown in FIG. 1, may be arranged in the workspace 102. The barcode reader 104 reads the barcode on the label sheet, and based on the barcode, the computer 105 identifies the product 7 as a target for label sheet affixation. The computer 105 receives information regarding the product 7 on the affixation line 202 from the computer 205, and verifies whether the product 7 on the affixation line 202 matches the product 7 identified by the barcode on the label sheet. If the product 7 on the affixation line 202 does not match the product 7 identified by the barcode on the label sheet, the computer 105 issues a warning to an assembly line worker. Warning notification methods are not limited and may employ various techniques. For example, the assembly line worker may be notified by outputting a warning image on an image display device (not shown). In another example, the assembly line worker may be notified by outputting a warning sound through a speaker (not shown).

In accordance with embodiments of the present invention, because a label sheet may be printed with cautionary measures 57 (see FIGS. 6 to 8), an assembly line worker can perform label affixation while referring to the printed cautionary measures. Therefore, the embodiments of the invention assure correct, safe and easy label affixation.

In accordance with an embodiment of the present invention, the affixation line 202 is located at a downstream end of the production line 200. Depending on the product 7, after the label is affixed to the product 7 in the affixation line 202, the product 7 may be carried to another location together with a product manual, such as a product instruction manual. In such a case, the label sheet produced with the printer 1 may be carried to the workspace 102 together with the product manual. The label sheet may be printed with information for verifying the product manual. The information printed on the label sheet and the product manual may be verified by an assembly line worker in order to select a suitable manual. Additionally, a barcode of the label sheet may be read with a barcode reader, and a suitable manual may be selected by the assembly line worker based on the result of the barcode reading.

In the above embodiment, the label production system 100 is disposed away from the production line 200. However, in another embodiment, the label production system 100 may be disposed in the vicinity of the production line 200. Disposing the label production system 100 in the vicinity of the affixation line 202 eliminates the necessity for the shelf 101 and for carrying the label sheets from the shelf 101 to the shelf 103. By adjusting the timing in which the label sheet is produced with the printer 1 to the timing in which the product 7 is carried to the affixation line 202, the label sheet produced with the printer 1 can be used immediately, and storage and carriage of the label sheet can be omitted.

In accordance with embodiments of the present invention, a production status of the production line 200 may be controlled by the computer 205 by suitably using various assisting devices. For example, as shown in FIG. 1, an assisting device such as a barcode reader 110 may be disposed in a specific area relative to the assembly line 201. The barcode reader 110 may then read a barcode affixed to the product 7 to enhance the efficiency in determining where a particular model of the product 7 is located. The data read by the barcode reader 110 is transmitted to the computer 205, and the data regarding the production status of the production line 200 is transmitted from the computer 205 to the computer 70. Alternatively, the data read by the barcode reader 110 may be transmitted to the computer 70 directly.

In the above description, only selected embodiments have been chosen to illustrate embodiments of the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

The foregoing embodiments and advantages are merely exemplary and are not to be construed as limiting the embodiments of the present invention. The present teaching can be readily applied to other types of apparatuses. The description of the embodiments of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A label production system producing labels for affixation to one or more types of products successively produced in an industrial production line, the label production system comprising:
a printer for printing on and cutting a medium, wherein the medium comprises a first sheet and a second sheet laminated onto the first sheet, and wherein the printer comprises an ink head for printing on the second sheet of the medium and a cutter for cutting at least the second sheet of the medium; and
a computer for controlling the printer to produce at least one label for each of one or more products produced in the production line by controlling the printer to print on and cut a contour on the second sheet of the medium, wherein the computer comprises:
an input unit for receiving information for each product produced in the production line, the information related to at least a type of each product produced and an order of production,
a storage unit having stored data for producing labels corresponding to each type of product produced in the production line,
a reading unit for receiving the information received by the input unit and reading data from the storage unit for each product produced in the production line according to the type of each product and the order of production,
a first control unit for transmitting the data read by the reading unit to the printer and controlling the printer to print on and cut a contour on the second sheet of the medium to generate the at least one label for a specific product produced in the production line according to the data read by the reading unit, and
a second control unit for receiving the information received by the input unit and controlling the printer to print on the second sheet of the medium identification information for identifying a type of the specific product according to the information received by the input unit.

2. The system of claim 1, wherein the first control unit controls the printer to generate a plurality of labels on the second sheet of the medium to form a label sheet corresponding to the specific product according to the data read by the reading unit.

3. The system of claim 2, wherein the first control unit controls the printer to generate a plurality of label sheets on the second sheet of the medium according to the data read by the reading unit, wherein each of the plurality of label sheets are separated from each other on the second sheet of the medium and respectively correspond to each product produced in the production line.

4. The system of claim 1, wherein the input unit further receives information for identifying the specific product produced in the production line, and the identification information printed on the second sheet of the medium includes information for identifying the specific product.

5. The system of claim 1, wherein the at least one label comprises at least one printed character printed in a language according to a destination of the specific product produced in the production line.

6. The system of claim 1, wherein a shape of the at least one label is cut according to the type of the specific product produced in the production line.

7. The system of claim 2, wherein a number of labels in the label sheet is dependent on the type of the specific product produced in the production line.

8. The system of claim 1, wherein a character printed on the at least one label is dependent on the type of the specific product produced in the production line.

9. The system of claim 1, wherein the computer further comprises:
a second storage unit having stored information related to cautionary measures for the one or more products produced in the production line; and
a third control unit for receiving the stored information related to the cautionary measures from the second storage unit, wherein the third control unit controls the printer to print on the second sheet of the medium a respective cautionary measure for each product produced in the production line.

10. The system of claim 1, wherein the input unit receives the information related to at least a type of each product produced and an order of production from a computer controlling the production line,
wherein the input unit further receives from the computer controlling the production line, information related to a production status of each product produced in the production line, and
wherein, for each product, a timing of the first control unit generating the at least one label and the second control unit printing the identification information is controlled according to the production status of each product.

11. A method for producing labels for affixation to one or more types of products successively produced in an industrial production line, the method comprising:
printing on and cutting a medium set into a printer, wherein the medium comprises a first sheet and a second sheet laminated onto the first sheet, and wherein the printer comprises an ink head for printing on the second sheet of the medium and a cutter for cutting at least the second sheet of the medium;
controlling, via a computer, the printer to produce at least one label for each of one or more products produced in the production line by controlling the printer to print on and cut a contour on the second sheet of the medium;
receiving, via an input unit of the computer, information for each product produced in the production line, the information related to at least a type of each product produced and an order of production;
storing, in a storage unit of the computer, data for producing labels corresponding to each type of product produced in the production line;
receiving, via a reading unit of the computer, the information received by the input unit and reading, via the reading unit, data from the storage unit for each product produced in the production line according to the type of each product and the order of production;
transmitting, via a first control unit of the computer, the data read by the reading unit to the printer and controlling, via the first control unit, the printer to print on and cut a contour on the second sheet of the medium to generate the at least one label for a specific product produced in the production line according to the data read by the reading unit; and
receiving, via a second control unit of the computer, the information received by the input unit and controlling, via the second control unit, the printer to print on the second sheet of the medium identification information for identifying a type of the specific product according to the information received by the input unit.

12. The method of claim 11, wherein the first control unit controls the printer to generate a plurality of labels on the second sheet of the medium to form a label sheet corresponding to the specific product according to the data read by the reading unit.

13. The method of claim 12, wherein the first control unit controls the printer to generate a plurality of label sheets on the second sheet of the medium according to the data read by the reading unit, wherein each of the plurality of label sheets are separated from each other on the second sheet of the medium and respectively correspond to each product produced in the production line.

14. The method of claim 11, wherein the input unit further receives information for identifying the specific product produced in the production line, and the identification information printed on the second sheet of the medium includes information for identifying the specific product.

15. The method of claim 11, wherein the at least one label comprises at least one printed character printed in a language according to a destination of the specific product produced in the production line.

16. The method of claim 11, wherein a shape of the at least one label is cut according to the type of the specific product produced in the production line.

17. The method of claim 12, wherein a number of labels in the label sheet is dependent on the type of the specific product produced in the production line.

18. The method of claim 11, wherein a character printed on the at least one label is dependent on the type of the specific product produced in the production line.

19. The method of claim 11, further comprising:
storing, via a second storage unit of the computer, information related to cautionary measures for the one or more products produced in the production line; and
receiving, via a third control unit of the computer, the stored information related to the cautionary measures from the second storage unit, wherein the third control unit controls the printer to print on the second sheet of the medium a respective cautionary measure for each product produced in the production line.

20. The method of claim 11, wherein the input unit receives the information related to at least a type of each product produced and an order of production from a computer controlling the production line,
wherein the input unit further receives from the computer controlling the production line, information related to a production status of each product produced in the production line, and
wherein, for each product, a timing of the first control unit generating the at least one label and the second control unit printing the identification information is controlled according to the production status of each product.
